(19) United States
(12) Patent Application Publication
(10) Pub. No.: US 2007/0215298 A1
(43) Pub. Date: Sep. 20, 2007

(54) Dual umbrella structure sunshade for vehicles

(76) Inventor: Lili Chen, Zhejiang (CN)

Correspondence Address: Donald W. Meeker;Patent Agent, 924 East Ocean Front #E, Newport Beach, CA, 92661, US

(21) Appl. No.: 11/376,852

(22) Filed: Mar. 16, 2006

(51) Int. Cl. B60J 1/20

(52) U.S. Cl. 160/370.21

(57) ABSTRACT

A sunshade for a motor vehicle supported by two umbrella structures, which are mounted by suction cups on the front windshield and rear window of the vehicle. Locking levers control the suction cups. The telescoping umbrella support structures elevate the sunshade spread out above the vehicle to shade the vehicle interior.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to vehicle sunshades and in particular to a vehicle sunshade supportable by two extensible and retractable umbrella type support rods with radial support arms, each attached to a base having a suction cup with a locking pivotable activating arm, the suction cups attachable to the glass surfaces of a windshield and rear window of the vehicle.

2. Description of Related Art Including Information Disclosed Under 37 CFR 1.97 and 1.98

Vehicle interiors reach extreme temperatures when exposed to direct sunlight; temperatures too high for living creatures and people to survive if locked within the vehicle for a prolonged period of time. When a person gets into a vehicle exposed to direct sun, the seats, steering wheel and other elements of the vehicle interior are usually too hot to contact.

Prior art sunshades are often difficult to set up and take down or inadequate in allowing air circulation between the sunshade and the vehicle to further assist in maintaining a cooler vehicle interior.

Prior art U.S. Pat. No. 4,655,236, issued Apr. 7, 1987 to Dorame, shows a portable carport that includes a foldable cover supported at its four corners by four telescoping assemblies each including an outwardly inclined telescoping mast. Each mast includes first and second anchoring legs, each having a foot wedged between the ground and the front and rear portions of the tread of the vehicle, respectively. A lateral anchoring assembly attached to each mast includes a lateral member having a plate which presses against an upper portion of the side wall of the adjacent tire and a clamp device that extends across the tread to engage the opposite inner wall of that tire and pulls the mast toward the tire, forcing the plate against the outer side wall, thereby maintaining the mast at a fixed angle of inclination relative to the plane of the tire. A removable spacer resting on the roof of the automobile pushes the center of the flexible cover upward to provide an air space between it and the top of the automobile. This allows rainfall to run off the top of the cover.

Prior art U.S. Pat. No. 4,858,985, issued Aug. 22, 1989 to Wojcik, claims a vehicle cover protector which protects most exposed parts of a motor vehicle from harsh climatic conditions including sun, rain, chemical fallout, pollution, dust, snow, sleet and hail. The cover is attached either within the vehicle or attached externally, mounted within a housing. A retractable cover covers the surface of the car. The cover may also be mounted over supporting members in order to provide additional protection from damage due to hail. The cover may be mounted upon two adjustable poles, which further provides for a sunshade available to persons or objects adjacent to the vehicle.

Prior art U.S. Pat. No. 4,805,654, issued Feb. 21, 1989 to Wang, illustrates a sun shield for automobiles which has a collapsible framework for supporting a flexible cloth. The framework has at least three legs radially and isometrically extended from the framework. In the free end of each leg there is a sucker adapted to attach to the roof of an automobile. Therefore, the cloth can be easily mounted above an automobile to shade it from the unpleasant and damaging effects of the sun's rays, and it can also be easily detached from the roof of the automobile and folded into the trunk of the automobile.

Prior art U.S. Pat. No. 5,388,883, issued Feb. 14, 1995 to Yang, relates a sun shield cover for a vehicle and the like is formed from a round-shaped and lightweight plastic sheet with an apron around the side. An elastic wire is sewn around to support the round shape. After one pushes the round shape into an oval one, two non-elastic plastic belts are used to keep the oval shape. A thin elastic wire is used to raise the central part of the oval-shaped shield to an umbrella shape. Two ear-shaped belts on the side of the shield are connected to the elastic fixing belt to fix the whole shield onto the top of the vehicle.

Prior art U.S. Pat. No. 5,921,259, issued Jul. 13, 1999 to Ehler, concerns a portable vehicle shade assembly. The shade assembly comprises a canopy, a support structure coupled with the canopy, a support member operably coupled with the support structure for moving the support structure from a first position to a second position for moving the canopy from a closed position to an open position, and an engagement mechanism for detachably engaging the support member with the body of the vehicle, the canopy to extend outwardly from the support member in the open position to substantially shade the compartment of the vehicle exteriorly of the compartment.

Prior art U.S. Pat. No. 5,040,557, issued Aug. 20, 1991 to Morgan, puts forth a vehicle cover system that has front and rear frames disposed to be suspended at a single support point at the front and a single support point at the rear of a vehicle, midway between the sides of the vehicle, preferably at the front and rear license plate mounting means. A cover having a transverse peak attaches to the front and rear frames and extends over the vehicle and down the sides. A carrier is disposed intermediate the ends of the vehicle, rests on the vehicle and extends downwardly at the sides of the vehicle and lifts the cover away from the top and the sides of the vehicle. The cover is held clear of the front and rear of the vehicle by the frames, allowing air to circulate between the vehicle and the cover. The front and rear frames and the carrier telescope in order to be stored and the front and rear frames may be locked in place.

Prior art U.S. Pat. No. 4,684,165, issued Aug. 4, 1987 to Becker, is for a motor vehicle sun screen apparatus comprising a cover that is draped over a roof rack frame, a front frame and rear frame. Each frame has depending legs terminating in a suction cup that is attached to a surface of a motor vehicle. The edges of the cover have reinforced holes. At least two tie-down members are attached at one end to the holes on each front and rear edge of the cover. The lower edge of the vehicle engages the other end of each tie-down member.

Prior art U.S. Pat. No. 5,438,457, issued Aug. 1, 1995 to Moore, shows an obstruction eliminator with a circular base having a mounting end, a receiving end, and an intermediate surface therebetween. The mounting end has a suction cup thereaffixed. The intermediate surface has a pair of apertures diametrically opposed. A lever is rotatably received within the apertures of the intermediate surface of the circular base. A securement arm is secured to the lever and secured to the suction cup. A support post is secured within the receiving end of the circular base. Two mirror assemblies, each of which are rotatably secured to the support post. Two adjustable mirrors, each of which are rotatably secured to the two mirror assemblies.

Prior art U.S. Pat. No. 3,957,301, issued May 18, 1976 to Huber, claims a vehicle sun shade or sunscreen which is removeably mounted on the top of a vehicle. The device includes a rigid frame, front and back collapsible sunscreen panels which cover the front and back vehicle windows and rotate from a shading position into a storage position and a pair of side window screens which are rotatably connected to the frame to move in the plane of the rigid screen from a sunscreen position rotatable into a storage position. The side window screens include a plurality of telescopically adjustable supporting rods. A flexible material is utilized to provide the sunscreen and is attached by suitable clips or brackets, both on the front, rear and side supporting arm members. The sunscreen is collapsible to a storage position to allow access to the vehicle and utilization of the vehicle. The frame may also include support members to be utilized as a storage or luggage rack for the vehicle.

Prior art U.S. Patent Application #20020139403A1, published Oct. 3, 2002 by Shi, illustrates an automobile umbrella comprising a sun shield device for protecting either a small area or a large area of a vehicle. A first embodiment employs a square umbrella supported by its post on an H-shaped support bracket attached to the vehicle by suction cups. A second embodiment employs a ball with four suction cupped legs, the umbrella shaft being inserted into a bore defined through the ball. The third embodiment employs a large sheet supported by rods attached to magnetic bases by ball and socket joints. The sheet can be rolled up for storage or travel, and unrolled to cover a van.

Prior art U.S. Pat. No. 1,006,315, issued Oct. 17, 1911 to Toth, relates an adjustable mirror having a base with a built-in mechanically activated suction cup which may be releasably secured to a surface such as a wall or mirror.

Prior art U.S. Pat. No. 5,566,030, issued Oct. 15, 1996 to Yue, concerns a multi-stage adjustable mirror support in a car, which has a sucker covered by a sucker cover and a post on the sucker. The post passes through the sucker cover; A press body which is on the sucker cover connects the post pivotedly. The front of the sucker cover receives a gear seat. The gear seat has a chamber to receive a gear, a hole and a recess. A lower link has two parallel side plates to receive the front of the sucker cover. The upper end of the lower link receives the lower end of the middle link pivotedly. An upper link has two parallel side plates to receive the upper end of the middle link pivotedly. The interspace between the upper ends of the spaced side plates receives two arms of a swivel. The swivel has a ball end and two parallel arms. Each arm has a central hole. The interspace between two parallel arms receives a gear seat. The gear seat has a chamber to receive a gear, a hole and a recess. The upper link, the gear seat and the swivel are connected pivotedly.

Prior art U.S. Pat. No. 5,401,074, issued Mar. 28, 1995 to Timerman, puts forth a vehicle cover that protects a vehicle from hail and other falling objects and is easily installed, removed, and stored in the trunk of the vehicle. The cover is substantially comprised of a sheet of cloth, several foam runners, and several attaching straps. The foam runners, preferably having a rectangular cross section, attach to the underside of the cloth. When placed on a vehicle, the foam runners support the cloth in a spaced apart relationship with the top of the vehicle. The attaching straps securely attach the cover to the vehicle by attaching to the wheel wells and the front and rear bumpers of the vehicle. The attaching straps hold the cloth in a taut condition so that the cloth remains in a spaced apart relationship with the top of the vehicle. Falling objects, such as hail, are repelled by the taut cloth and damage to the vehicle is prevented. The foam runners and straps are adjustable so that the cover fits a variety of vehicles.

What is needed is a vehicle sunshade which mounts and removes easily by a single person and which supports the sunshade over the entire vehicle interior slightly elevated above the vehicle to allow air circulation between the sunshade and the vehicle.

### BRIEF SUMMARY OF THE INVENTION

An object of the present invention is to provide a vehicle sunshade which mounts and removes easily by a single person and which supports the sunshade over the entire vehicle interior slightly elevated above the vehicle to allow air circulation between the sunshade and the vehicle.

Another object of the present invention is to provide a vehicle sunshade having dual umbrella supports which are mounted to the windshield and rear window by using a mechanically activated suction cup base which comprises a locking mechanism to releasably and securely attach the suction base to the glass and to prevent theft of the umbrella supports.

In brief, the present invention provides a sunshade for a vehicle supported by dual umbrella structures. The umbrella support structures mount, one on the front windshield and one on the rear window of the vehicle. The umbrella supports use a strong mechanically activated suction cup to mount on each window. The sunshade is easy to mount and each of the upright umbrella supports from each of the two suction cup mounts is positioned strategically, well along the length of the sunshade, so that only the two supports are required to hold the sunshade in an elevated position above the vehicle for adequate shading of the vehicle. The suction cup mounting bases each have a locking mechanism, such as an upright lock bar that inserts within an opening through a suction-controlling lever arm. The locking mechanism locks to secure the lever arm down in the suction position, and is releasable only by using a key.

An advantage of the present invention is that mounting it on the windshield and rear window provide ease of installation and access.

A further advantage of the present invention is that mounting it on the windshield and rear window with umbrella type mounts positions the mounts in the optimum location for sharing the support of the sunshade material and maintaining it above the vehicle with air circulating between the sunshade and the vehicle.

Another advantage of the present invention is that the umbrella type mounts are releasably and securely attached to the glass.

Yet another advantage of the present invention is that the locking suction bases prevent theft.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a side elevational view of the suction support base of FIG. 1;

FIG. 2 is a perspective view of the suction support base of the present invention showing the associated key;

FIG. 3 is a side elevational view of the sunshade of the present invention mounted on a station wagon type vehicle;

FIG. 4 is a side elevational view of the vehicle of FIG. 3 with the sunshade device of the present invention shown in partial cross-section mounted on the vehicle showing the telescoping support arm and peripheral axial support arms and the sunshade support material mounted on the axial support arms;

FIG. 5 is a side elevational view of a sports car type vehicle with the sunshade device of the present invention shown in partial cross-section mounted on the vehicle with the two umbrella type sunshade supports mounted on the windshield and back window and showing the suction cup base supporting a telescoping support arm and peripheral axial support arms and the sunshade support material mounted on the axial support arms;

FIG. 6 is a side elevational view of the sunshade of FIG. 5 mounted on the sports car-type vehicle of FIG. 5.

### DETAILED DESCRIPTION OF THE INVENTION

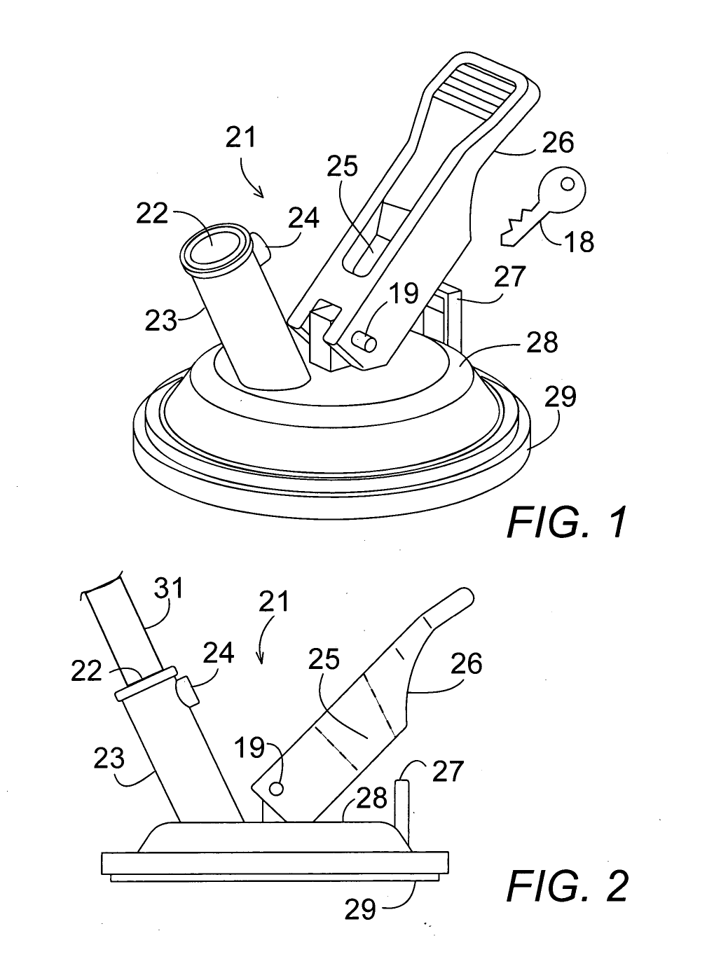

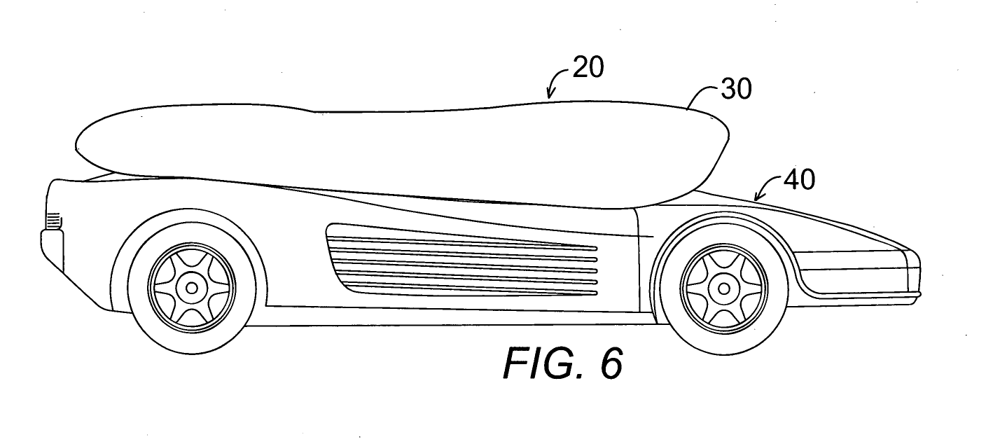

In FIGS. 1-6, sunshade device 20 for a passenger compartment of a vehicle 40 is attachable to the windshield 41 and rear window 42.

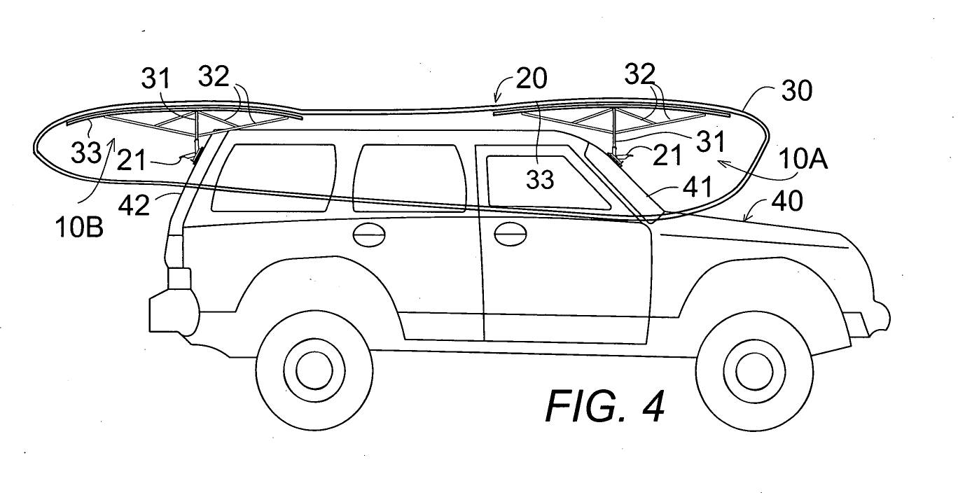

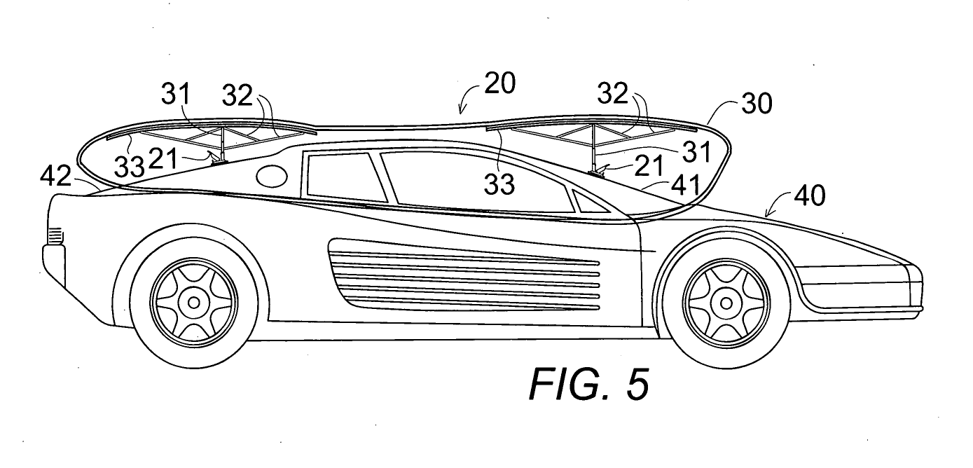

The sunshade device 20 comprises a front support 10A and a rear support 10B mountable on the glass surface of a windshield 41 and a rear window 42 respectively of a vehicle 40, as shown in FIGS. 4 and 5. Each of the supports 10A and 10B comprise a suction cup base 21 with a suction cup 29 forming a bottom surface and a locking lever arm 26, positioned on a top surface 28, as shown in FIGS. 1 and 2. The locking lever arm 26 is pivotable relative to the base 21 to create suction between the suction cup 29 and one of the glass surfaces 41 and 42 with the lever 26 pivoted to a downward position. A locking mechanism, such as an upright lock bar 27 is insertable within an opening 25 through the lever arm 26 to admit the lock bar 27 therein, which locks to secure the lever arm 26 down in the suction position on the lever arm 26, thereby locking the lever arm 26 in the downward position to lock the suction cup 29 onto the glass surface 41 and 42. The locking mechanism 27 has an insertable key 18 to unlock the locking mechanism 27 and to allow the lever arm 26 to be pivoted up into an upward position to release the suction between the suction cup 29 and the glass 41 and 42.

The sunshade device 20 also comprises an upright telescoping support 31 extending vertically from each of the suction cup bases 21 and anchored in a sleeve 23 with a control button 24 to work the umbrella and a sleeve 23 to retain the telescoping support 31. The telescoping support 31 comprises a telescoping center support rod 31 extensible and retractable, a series of retractable arms 32 extending radially outward from the top of the support rod 31, and a sheet 33 of sunshade support material attached to the series of retractable arms 32, as seen in FIGS. 4 and 5.

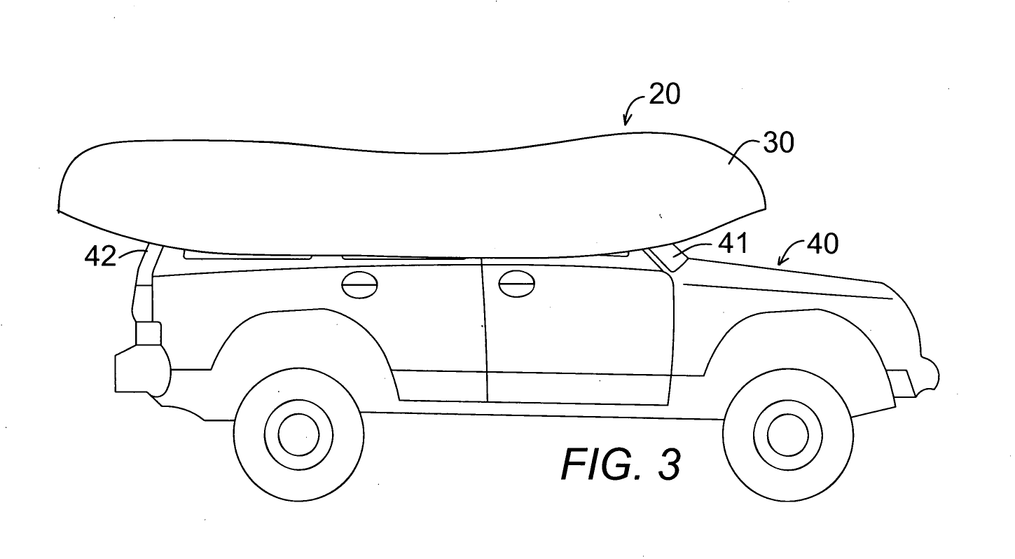

The sunshade device 20 further includes a sunshade 30 comprising a sheet of weatherproof material attached to and supported by the sunshade support material 33 of the two telescoping supports 31, so that the sunshade 30 extends over a passenger compartment of the vehicle 40 to shade an interior of the vehicle 40, as shown in FIGS. 3-6.

The telescopic support 31 comprises a telescoping rod which is manually extended from a first contracted position so that the rod telescopes upward to a second extended position, shown in FIGS. 4 and 5, locked in place to support the sunshade and wherein pressing a control button 24 releases the locking device so that the support rod manually telescopes downward to the first contracted position.

In use, the dust is cleaned from the windshield 41 and rear window 42 at the locations where the suction cups 29 are to be mounted. The umbrella 32 and 33 of the front support 10A is opened manually. The suction cup 29 is placed against the windshield 41 preferably in a lower middle location, as seen in FIGS. 4 and 5. The suction cup base 21 is pressed down on the windshield 41 to create suction between the suction cup 29 and the windshield 41. The handle 26 is pivoted down and locked to secure the suction cup 29 to the windshield 41. The rear support 10B is then applied in a similar fashion on the rear window 42. Next, the sunshade 30 is placed over the sunshade support material 33 and retractable arms 32 of the front 10A and rear 10B supports, as in FIGS. 3-6 or the sunshade 30 may be pre-attached to the sunshade support material 33.

To remove front 10A or rear 10B supports, the button 24 is pressed to release the telescoping support and the umbrella 32 and 33 is closed manually. An insertable key 18 is used to unlock the locking mechanism 27 and to allow the lever arm 26 to be pivoted up into an upward position to release the suction between the suction cup 29 and the glass 41 and 42, as seen in FIG. 1.

It is understood that the preceding description is given merely by way of illustration and not in limitation of the invention and that various modifications may be made thereto without departing from the spirit of the invention as claimed.

What is claimed is:

1. A sunshade device for a passenger compartment of a vehicle attachable to the windshield and rear window, the device comprising:
a front support and a rear support mountable on the glass surface of a windshield and a rear window respectively of a vehicle, each of the supports comprising a suction cup base with a suction cup forming a bottom surface and a locking lever arm positioned on a top surface, the locking lever arm pivotable relative to the base to create suction between the suction cup and one of the glass surfaces with the lever pivoted to a downward position, a locking mechanism on the lever arm locking the lever arm in the downward position to lock the suction cup onto the glass surface, the locking mechanism having an insertable key to unlock the locking mechanism and to allow the lever arm to be pivoted up into an upward position to release the suction between the suction cup and the glass;
an upright telescoping support extending vertically from each of the suction cup bases, the telescoping support comprising a telescoping center support rod which is extensible and retractable, a series of retractable arms extending radially outward from a top of the support rod, and a sheet of sunshade support material attached to the series of retractable arms; and
a sunshade comprising a sheet of weatherproof material attached to and supported by the sunshade support material of the two telescoping supports so that the sunshade extends over a passenger compartment of the vehicle to shade an interior of the vehicle.
